(19) United States
(12) Patent Application Publication
(10) Pub. No.: US 2006/0282794 A1
(43) Pub. Date: Dec. 14, 2006

(54) Method of generating summary menu for storage medium

(75) Inventors: Min-Shu Chen, Linkou Township (TW); Kun-Ming Tien, Taipei City (TW)

Correspondence Address: SILICON VALLEY PATENT GROUP LLP, 2350 MISSION COLLEGE BOULEVARD, SUITE 360, SANTA CLARA, CA, 95054, US

(73) Assignee: Ulead Systems, Inc., Taipei (TW)

(21) Appl. No.: 11/197,958

(22) Filed: Aug. 5, 2005

(30) Foreign Application Priority Data
Jun. 10, 2005 (TW) 094119407

(51) Int. Cl. G06F 17/00

(52) U.S. Cl. 715/825; 715/828

(57) ABSTRACT

In the present invention, a method of generating a summary menu for a storage medium having a plurality of folders for storing a plurality of multimedia data is provided. The method includes steps of (a) reading the storage medium, (b) generating a plurality of menu buttons by searching the folders when the storage medium is first read, (c) generating a summary menu having the menu buttons and storing the menu buttons in a record file, (d) reading the record file when the storage medium has been read, and (e) displaying the summary menu.

### FIELD OF THE INVENTION

The present invention relates to a method of generating the summary menu, and more particularly to a method of generating the summary menu for the storage medium.

### BACKGROUND OF THE INVENTION

Due to the development of technology, the capacity of the optical storage medium is getting larger and larger. For example, the capacity of a one-layer Blu-ray™ disc is 25 GB (GigaByte), and the capacity of a one-layer HD-DVD (High Definition DVD) disc is 15 GB. Both the Blu-ray™ disc and the HD-DVD disc have a capacity much larger than that of an ordinary DVD-Video disc (4.7 GB). Therefore, such high capacity discs are capable of storing the data of multiple DVD-Video discs.

When the user burns the data of multiple DVD-Video discs onto a high capacity disc, such as a Blu-ray™ disc or a HD-DVD disc, the data are stored therein in a folder form, as shown in FIG. 1. As shown in FIG. 1, six folders are existed under the root of the storage medium 1. The six folders include three first-layer folders 11, 12 and 13 as well as three second-layer folders 111, 121 and 131, wherein the three second-layer folders 111, 121 and 131 are standard DVD-Video folders. Hence, when the user wants to play the data of one of the multiple DVD-Video discs, he has to browse each of the six folders 11, 12, 13, 111, 121 and 131 respectively to identify which folder the data of the desired DVD-Video disc are stored in. There is no reference information provided for the user before he identifies the folder that the data of the desired DVD-Video disc are stored in. Accordingly, the user has to spend a lot of time and efforts on searching the desired data. This results in a nuisance for the user.

From the above description, it is known that how to develop a method of generating the summary menu for the storage medium automatically has become a major problem waited to be solved. In order to overcome the drawbacks in the prior art, an improved method of generating the summary menu for the storage medium is provided. The particular design in the present invention not only solves the problems described above, but also is easy to be implemented. Thus, the invention has the utility for the industry.

### SUMMARY OF THE INVENTION

In accordance with one aspect of the present invention, a method of generating the summary menu for the storage medium is provided. The method is used for generating the summary menu automatically. The summary menu has a plurality of menu buttons, each of which corresponds to the specific multimedia data in a folder of the storage medium.

According to the aspect of the present invention, a method of generating a summary menu for a storage medium having a plurality of folders for storing a plurality of multimedia data is provided. The method includes steps of (a) reading the storage medium, (b) generating a plurality of menu buttons by searching the folders when the storage medium is first read, (c) generating a summary menu having the menu buttons and storing the menu buttons in a record file, (d) reading the record file when the storage medium has been read, and (e) displaying the summary menu.

Preferably, the storage medium is a VCD, an SVCD, a DVD-Video disk, an HD-DVD, an HD-DVD-VR, a Blu-ray™ Disc (BD), a portable disc and a hard disc.

Preferably, the step (b) includes steps of (b1) searching the folders if a specific menu format is set by a user, (b1-1) selecting the specific menu format as a first corresponding menu button if the specific menu format exists in a specific folder of the folders, whereas selecting one of other menus in the specific folder of the folders as a second corresponding menu button if the specific menu format does not exist in the specific folder of the folders, (b1-2) selecting a portion of the multimedia data in the specific folder of the folders as a third corresponding menu button if no menu exists in the specific folder of the folders, (b2) searching the folders if the specific menu format is not set by the user, (b2-1) selecting one of a plurality of menus as the second corresponding menu button in a specific sequence if the menus exist in the specific folder of the folders, and (b2-2) selecting the portion of the multimedia data in the specific folder of the folders as the third corresponding menu button if no menu exists in the specific folder of the folders.

Preferably, the storage medium is the DVD-Video disk, and the specific menu format is one selected from a group consisting of a title menu, a root menu, a chapter menu, an audio menu, an angle menu and a subpicture menu.

Preferably, the menus in the specific folder of the folders are ones selected from a group consisting of the title menu, the root menu, the chapter menu, the audio menu, the angle menu, the subpicture menu and a combination thereof.

Preferably, the specific sequence is sequentially arranged in an order of the title menu, the root menu, the chapter menu, the audio menu, the angle menu and the subpicture menu.

Preferably, the method further includes a step of (f) performing a corresponding action when one of the menu buttons is selected.

Preferably, the corresponding action is to play corresponding multimedia data when the selected menu button is the portion of the multimedia data in the specific folder of the folders.

Preferably, the corresponding action is to enter the menu if the selected menu button is one of the title menu, the root menu, the chapter menu, the audio menu, the angle menu and the subpicture menu.

Preferably, the method further includes a step of (g) displaying the summary menu when a summary menu button on a control panel is selected.

According to the aspect of the present invention, a method of generating a summary menu for a storage medium having a plurality of folders for storing a plurality of multimedia data is provided. The method includes steps of (a) reading the storage medium, (b) generating a plurality of menu buttons by searching the folders, (c) generating a summary menu having the menu buttons, and (d) displaying the summary menu.

Preferably, the storage medium is a VCD, an SVCD, a DVD-Video disk, an HD-DVD, an HD-DVD-VR, a BD, a portable disc and a hard disc.

Preferably, the step (b) includes steps of (b1) searching the folders if a specific menu format is set by a user, (b1-1) selecting the specific menu format as a first corresponding menu button if the specific menu format exists in a specific folder of the folders, whereas selecting one of other menus in the specific folder of the folders as a second corresponding menu button if the specific menu format does not exist in the specific folder of the folders, (b1-2) selecting a portion of the multimedia data in the specific folder of the folders as a third corresponding menu button if no menu exists in the specific folder of the folders, (b2) searching the folders if the specific menu format is not set by the user, (b2-1) selecting one of a plurality of menus as the second corresponding menu button in a specific sequence if the menus exist in the specific folder of the folders, and (b2-2) selecting the portion of the multimedia data in the specific folder of the folders as the third corresponding menu button if no menu exists in the specific folder of the folders.

Preferably, the storage medium is the DVD-Video disk, and the specific menu format is one selected from a group consisting of a title menu, a root menu, a chapter menu, an audio menu, an angle menu and a subpicture menu.

Preferably, the menus in the folder are ones selected from a group consisting of the title menu, the root menu, the chapter menu, the audio menu, the angle menu, the subpicture menu and a combination thereof.

Preferably, the specific sequence is sequentially arranged in an order of the title menu, the root menu, the chapter menu, the audio menu, the angle menu and the subpicture menu.

Preferably, the method further includes a step of (f) performing a corresponding action when one of the menu buttons is selected.

Preferably, the corresponding action is to play a corresponding multimedia data if the selected menu button is the portion of the multimedia data in the specific folder of the folders.

Preferably, the corresponding action is to enter the menu if the selected menu button is one of the title menu, the root menu, the chapter menu, the audio menu, the angle menu and the subpicture menu.

Preferably, the method further includes a step of (g) displaying the summary menu when a summary menu button on a control panel is selected.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing the file structure of an ordinary disc in the prior art;

FIGS. 2(a) and 2(b) are flowcharts illustrating the method of generating the summary menu for the storage medium according to a preferred embodiment of the present invention; and

FIG. 3 is a diagram showing the summary menu according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

In order to solve the issue that the user has to spend a lot of time and efforts on searching the desired data in the storage medium, the present invention provides a new and practical method to solve the above drawback.

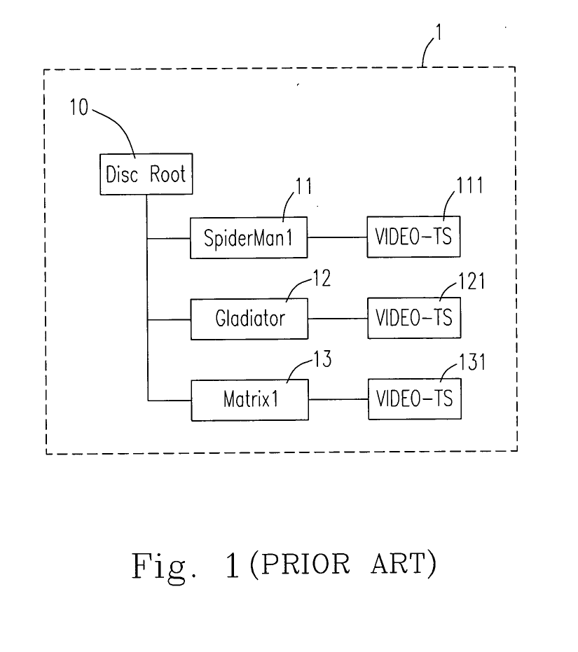

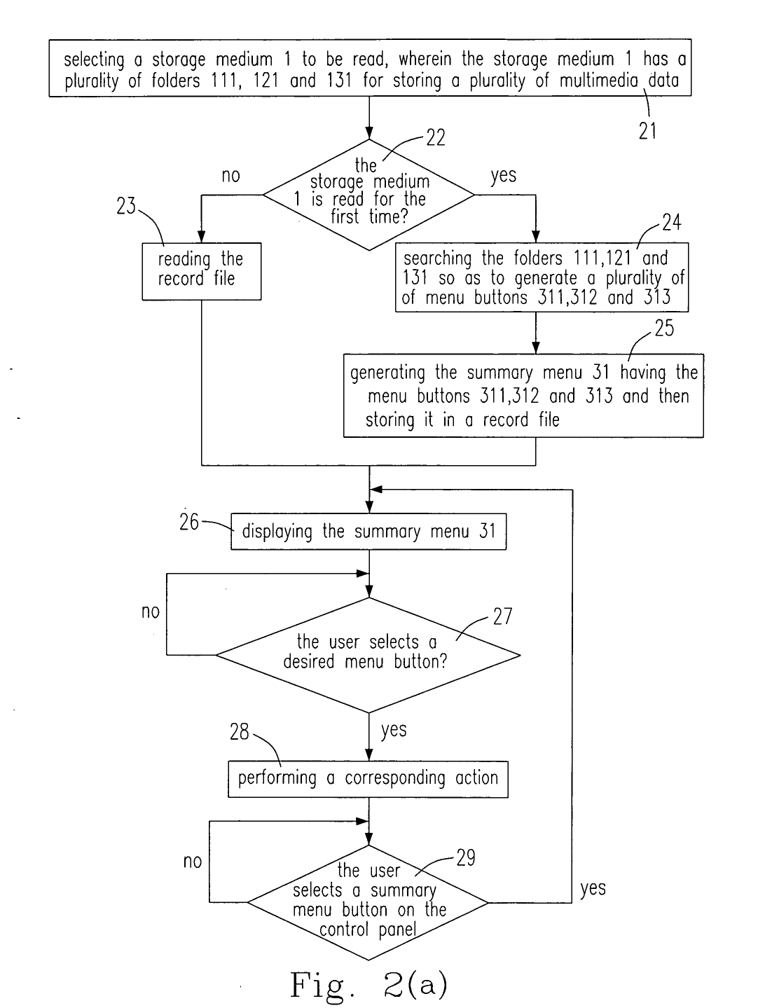

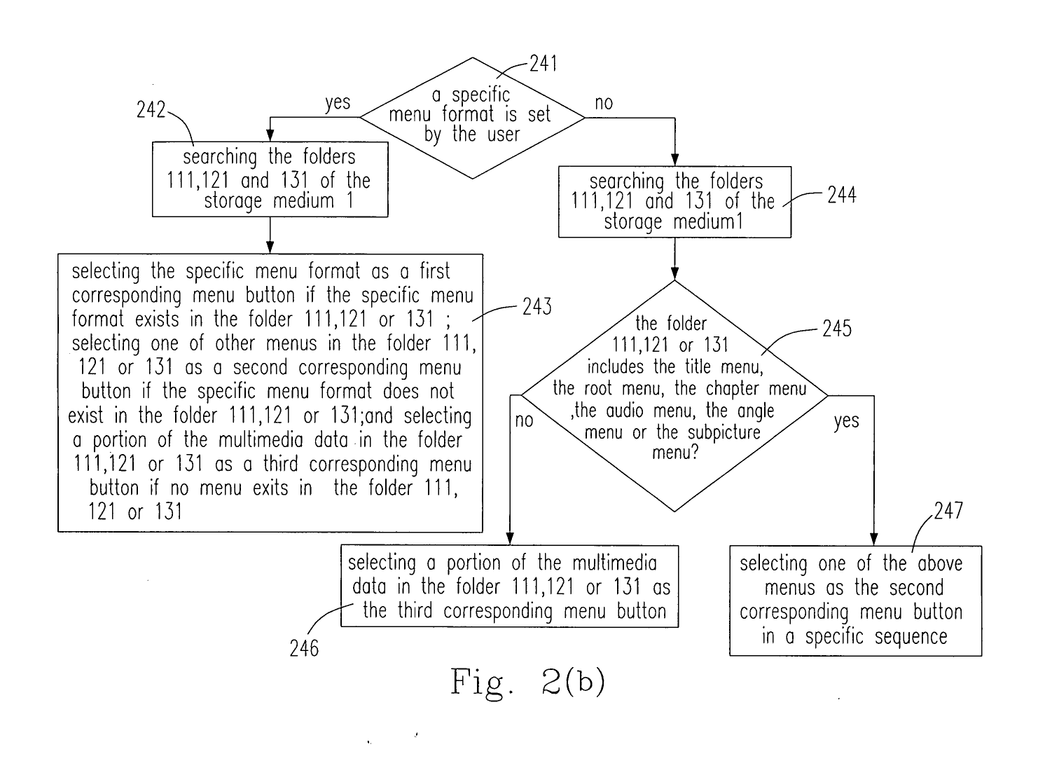

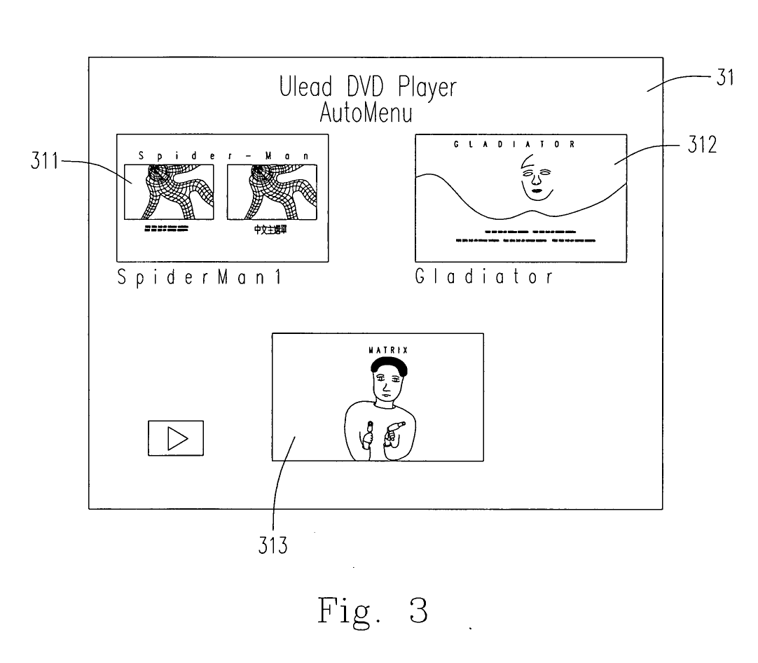

Please refer to FIG. 1, FIGS. 2(a) and 2(b), and FIG. 3, wherein FIGS. 2(a) and 2(b) are flowcharts illustrating the method of generating the summary menu for the storage medium according to a preferred embodiment of the present invention, and FIG. 3 is a diagram showing the summary menu according to a preferred embodiment of the present invention. In FIGS. 2(a) and 2(b), the storage medium is exemplified as a DVD-Video disk. The steps of the method are as follows.

At first, the storage medium 1 is selected and read, wherein the storage medium 1 has a plurality of folders 111, 121 and 131 for storing a plurality of multimedia data (step 21). Next, a judging process is performed to determine whether the storage medium 1 is read for the first time (step 22). If the storage medium 1 is read for the first time, the folders 111, 121 and 131 are searched so as to generate a plurality of menu buttons 311, 312 and 313 (step 24). Meanwhile, a summary menu 31 having the menu buttons 311, 312 and 313 is generated and then stored in a record file (step 25). Whereas, if the storage medium 1 is previously read, which means a record file storing the summary menu having the plurality of menu buttons therein is already generated, then the record file storing the summary menu 31 is directly read (step 23), so that the initialization time for the storage medium 1 is shortened.

The steps of generating the menu buttons 311, 312 and 313 are as follows.

Firstly, a detection process is performed to determine if a specific menu format is set by the user (step 241). For an ordinary DVD-Video, the menu format includes the title menu, the root menu, the chapter menu, the audio menu, the angle menu and the subpicture menu, and the user can set his favorite menu format as the specific menu format based on the above menus. Certainly, not every DVD-Video has all of the above menus. If the specific menu format is already set by the user, then the folders 111, 121 and 131 of the storage medium 1 are searched (step 242). If the specific menu format exists in the folder 111, 121 or 131, it would be selected as a first corresponding menu button. However, if the specific menu format does not exist in the folder 111, 121 or 131, one of other menus in the folder 111, 121 or 131 is selected as a second corresponding menu button. Besides, if no menu exists in the folder 111, 121 or 131, a portion of the multimedia data in the folder 111, 121 or 131 is selected as a third corresponding menu button (step 243).

If the specific menu format is not set by the user, then the folders 111, 121 and 131 of the storage medium 1 are also searched (step 244). When the folder 111, 121 or 131 includes the title menu, the root menu, the chapter menu, the audio menu, the angle menu or the subpicture menu (step 245), one of the above menus is selected as the second corresponding menu button in a specific sequence (step 247). For example, the second corresponding menu is selected in a sequence of the title menu, the root menu, the chapter menu, the audio menu, the angle menu and the subpicture menu. If no menu exists in the folder 111, 121 or 131, a portion of the multimedia data in the folder 111, 121 or 131 is selected as the third corresponding menu button (step 246). Each of the folders 111, 121 and 131 will be searched through the above steps for generating the first corresponding menu button, the second corresponding menu button or the third corresponding menu button.

The summary menu 31 having the menu buttons 311, 312 and 313 would be displayed on the screen after being generated (step 26). At this time, the user can select a desired menu button (step 27). While one of the menu buttons is selected by the user, a corresponding action would be performed (step 28). The corresponding action is to play corresponding multimedia data when the selected menu button 311, 312 or 313 is the portion of the multimedia data in the folder 111, 121 or 131. However, when the selected menu button 311, 312 or 313 is the title menu, the root menu, the chapter menu, the audio menu, the angle menu or the subpicture menu, the corresponding action is to enter the menu. During the process of playing the multimedia data, the system will detect whether the user selects a summary menu button on the control panel (step 29). When the summary menu button is selected by the user during the playing process, the procedure will proceed back to the step 26 for re-displaying the summary menu 31.

The storage medium 1 of the present invention is not limited to the DVD-Video disk, and a VCD, an SVCD, an HD-DVD, an HD-DVD-VR, a BD, a portable disc or a hard disc is also preferred. That is to say, no matter which type the storage medium 1 is, the method of the present invention is able to be employed to generate the summary menu 31, as long as the storage medium 1 stores the multimedia data in the folders thereof. Moreover, the multimedia data in the folders are not limited to the movies. Any kinds of video files are able to serve as the multimedia data of the present invention, such as the film shot by the user during his vacation. Besides, the method of the present invention is able to be carried out via the software.

In addition, the menu format described in the above embodiment is not limited to the title menu, the root menu, the chapter menu, the audio menu, the angle menu or the subpicture menu. Any kinds of interface capable of interacting with the user are able to serve as the menu of the present invention.

In conclusion, the present invention provides a method of generating the summary menu for the storage medium automatically. The summary menu has a plurality of menu buttons, each of which corresponds to the specific multimedia data in a folder of the storage medium. In this way, the corresponding multimedia data are able to be played simply by selecting the menu button on the screen. It is unnecessary for the user to spend lots of time and efforts on searching the file system in the storage medium for the desired multimedia data. Accordingly, the present invention efficiently solves the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method of generating a summary menu for a storage medium having a plurality of folders for storing a plurality of multimedia data, comprising steps of:
(a) reading said storage medium;
(b) generating a plurality of menu buttons by searching said folders when said storage medium is first read;
(c) generating a summary menu having said menu buttons and storing said summary menu in a record file;
(d) reading said record file when said storage medium has been read; and
(e) displaying said summary menu.

2. The method as claimed in claim 1, wherein said storage medium is a VCD, an SVCD, a DVD-Video disk, an HD-DVD, an HD-DVD-VR, a BD, a portable disc and a hard disc.

3. The method as claimed in claim 2, wherein said step (b) comprises steps of:
(b1) searching said folders if a specific menu format is set by a user;
(b1-1) selecting said specific menu format as a first corresponding menu button if said specific menu format exists in a specific folder of said folders, whereas selecting one of other menus in said specific folder of said folders as a second corresponding menu button if said specific menu format does not exist in said specific folder of said folders;
(b1-2) selecting a portion of said multimedia data in said specific folder of said folders as a third corresponding menu button if no menu exists in said specific folder of said folders;
(b2) searching said folders if said specific menu format is not set by said user;
(b2-1) selecting one of a plurality of menus as said second corresponding menu button in a specific sequence if said menus exist in said specific folder of said folders; and
(b2-2) selecting said portion of said multimedia data in said specific folder of said folders as said third corresponding menu button if no menu exists in said specific folder of said folders.

4. The method as claimed in claim 3, wherein said storage medium is said DVD-Video disk, and said specific menu format is one selected from a group consisting of a title menu, a root menu, a chapter menu, an audio menu, an angle menu and a subpicture menu.

5. The method as claimed in claim 4, wherein said menus in said specific folder of said folders are ones selected from a group consisting of said title menu, said root menu, said chapter menu, said audio menu, said angle menu, said subpicture menu and a combination thereof.

6. The method as claimed in claim 5, wherein said specific sequence is sequentially arranged in an order of said title menu, said root menu, said chapter menu, said audio menu, said angle menu and said subpicture menu.

7. The method as claimed in claim 6, further comprising a step of:
(f) performing a corresponding action when one of said menu buttons is selected.

8. The method as claimed in claim 7, wherein said corresponding action is to play corresponding multimedia data when said selected menu button is said portion of said multimedia data in said specific folder of said folders.

9. The method as claimed in claim 7, wherein said corresponding action is to enter said menu if said selected menu button is one of said title menu, said root menu, said chapter menu, said audio menu, said angle menu and said subpicture menu.

10. The method as claimed in claim 1, further comprising a step of:
(g) displaying said summary menu when a summary menu button on a control panel is selected.

11. A method of generating a summary menu for a storage medium having a plurality of folders for storing a plurality of multimedia data, comprising steps of:
(a) reading said storage medium;
(b) generating a plurality of menu buttons by searching said folders;
(c) generating a summary menu having said menu buttons; and
(d) displaying said summary menu.

12. The method as claimed in claim 11, wherein said storage medium is a VCD, an SVCD, a DVD-Video disk, an HD-DVD, an HD-DVD-VR, a BD, a portable disc and a hard disc.

13. The method as claimed in claim 12, wherein said step (b) comprises steps of:
(b1) searching said folders if a specific menu format is set by a user;
(b1-1) selecting said specific menu format as a first corresponding menu button if said specific menu format exists in a specific folder of said folders, whereas selecting one of other menus in said specific folder of said folders as a second corresponding menu button if said specific menu format does not exist in said specific folder of said folders;
(b1-2) selecting a portion of said multimedia data in said specific folder of said folders as a third corresponding menu button if no menu exists in said specific folder of said folders;
(b2) searching said folders if said specific menu format is not set by said user;
(b2-1) selecting one of a plurality of menus as said second corresponding menu button in a specific sequence if said menus exist in said specific folder of said folders; and
(b2-2) selecting said portion of said multimedia data in said specific folder of said folders as said third corresponding menu button if no menu exists in said specific folder of said folders.

14. The method as claimed in claim 13, wherein said storage medium is said DVD-Video disk, and said specific menu format is one selected from a group consisting of a title menu, a root menu, a chapter menu, an audio menu, an angle menu and a subpicture menu.

15. The method as claimed in claim 14, wherein said menus in said folder are ones selected from a group consisting of said title menu, said root menu, said chapter menu, said audio menu, said angle menu, said subpicture menu and a combination thereof.

16. The method as claimed in claim 15, wherein said specific sequence is sequentially arranged in an order of said title menu, said root menu, said chapter menu, said audio menu, said angle menu and said subpicture menu.

17. The method as claimed in claim 16, further comprising a step of:
(f) performing a corresponding action when one of said menu buttons is selected.

18. The method as claimed in claim 17, wherein said corresponding action is to play a corresponding multimedia data if said selected menu button is said portion of said multimedia data in said specific folder of said folders.

19. The method as claimed in claim 17, wherein said corresponding action is to enter said menu if said selected menu button is one of said title menu, said root menu, said chapter menu, said audio menu, said angle menu and said subpicture menu.

20. The method as claimed in claim 11, further comprising a step of:
(g) displaying said summary menu when a summary menu button on a control panel is selected.
